(19) United States
(12) Patent Application Publication
(10) Pub. No.: US 2026/0177031 A1
(43) Pub. Date: Jun. 25, 2026

(54) MINIMIZING WAKE LOSS IN WIND FARMS

(71) Applicant: International Business Machines Corporation, Armonk, NY (US)

(72) Inventors: Sarbajit Kumar Rakshit, Kolkata (IN); Manikandan Padmanaban, Chennai (IN); Jagabondhu Hazra, Bangalore (IN)

(21) Appl. No.: 18/991,626

(22) Filed: Dec. 22, 2024

(51) Int. Cl. F03D 7/04; F03D 7/02

(52) U.S. Cl. CPC F03D 7/049; F03D 7/0224; F05B 2270/204

(57) ABSTRACT

A computer-implemented method, system, and computer program product for minimizing wake loss in wind farms. The optimal values for the power coefficient and the thrust coefficient for each of the wind turbines (e.g., 4D printed wind turbines) in the wind farm that minimize the aggregated wake loss for the wind farm are determined. The wind turbine controllers for each of the wind turbines are then instructed to change the pitch angle and the tip speed ratio for the wind turbines in the wind farm using external stimuli to dynamically adjust the power coefficient and the thrust coefficient for each of the wind turbines to correspond to the optimal values that results in minimizing the aggregated wake loss for the wind farm. In this manner, the overall wake loss in the wind farm is effectively minimized thereby maximizing the collective wind power generation in the wind farm.

### TECHNICAL FIELD

The present disclosure relates generally to wind farms, and more particularly to minimizing wake loss in wind farms.

### BACKGROUND

A wind farm, also known as a wind park, is a collection of wind turbines that work together to generate electricity from the wind. Wind turbines convert the wind's kinetic energy into mechanical energy, which is then converted into electricity. The electricity is sent to the electric grid for consumption.

### SUMMARY

In one embodiment of the present disclosure, a computer-implemented method for minimizing wake loss in wind farms comprises determining a first value for a power coefficient and a second value for a thrust coefficient for a wind turbine in a wind farm that minimize aggregated wake loss for the wind farm. The method further comprises instructing a wind turbine controller to change a pitch angle and a tip speed ratio for the wind turbine in the wind farm using external stimuli to cause a value of the power coefficient and a value of the thrust coefficient for the wind turbine in the wind farm to correspond to the first value and the second value, respectively.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a wind farm that includes a collection of wind turbines that work together to generate electricity from the wind;

FIG. 2 is a diagram of the software components of the wake loss minimizer used for minimizing the overall wake loss in the wind farm thereby maximizing the collective wind power generation in the wind farm in accordance with an embodiment of the present disclosure;

FIG. 3 is a three-dimensional (3D) graph illustrating that the power coefficient, Cₚ, is a function of pitch angles (β) and the tip speed ratio, λ, in accordance with an embodiment of the present disclosure;

FIG. 4 is a three-dimensional (3D) graph illustrating that the thrust coefficient, C_{T}, is a function of pitch angles (β) and the tip speed ratio, λ, in accordance with an embodiment of the present disclosure;

FIG. 5 illustrates a three-dimensional (3D) lookup table that identifies the required external stimuli to be applied to the wind turbine to adjust the power coefficient and the thrust coefficient appropriately in accordance with an embodiment of the present disclosure;

FIG. 6 illustrates an embodiment of the present disclosure of the hardware configuration of the wake loss minimizer which is representative of a hardware environment for practicing the present disclosure; and

FIG. 7 is a flowchart of a method for minimizing the overall wake loss in the wind farm thereby maximizing the collective wind power generation in the wind farm in accordance with an embodiment of the present disclosure.

### DETAILED DESCRIPTION

As stated above, a wind farm, also known as a wind park, is a collection of wind turbines that work together to generate electricity from the wind. Wind turbines convert the wind's kinetic energy into mechanical energy, which is then converted into electricity. The electricity is sent to the electric grid for consumption.

Such power (“wind power”) generated by wind farms is a renewable energy source that creates no solid waste, greenhouse gases, or other air pollutants. It also uses no water to generate electricity.

Unfortunately, wind farms experience a loss of wind power energy due to “wake loss.” Wake loss is the reduction in wind speed and energy production caused by the wake effect of upstream wind turbines on downstream turbines. Wake losses can significantly impact the efficiency and performance of wind farms. For example, energy losses due to wake losses are approximately 5-10% for onshore wind farms and approximately 15% for offshore wind farms.

Attempts have been made to mitigate the negative effects of wake loss. For example, attempts have been made to lessen the energy losses due to wake losses through turbine placement strategies and load distribution adjustments. In another example, data-driven model and machine learning techniques have been used to analyze and mitigate wake losses.

Unfortunately, such attempts have been inadequate in minimizing wake losses, which reduces the energy production of the wind farm.

The embodiments of the present disclosure provide a means for minimizing the overall wake loss in the wind farm thereby maximizing the collective wind power generation in the wind farm. In one embodiment, the optimal values for the power coefficient and the thrust coefficient for each of the wind turbines (e.g., 4D printed wind turbines) in the wind farm that minimize the aggregated wake loss for the wind farm are determined. The power coefficient (Cₚ) of a wind turbine, as used herein, refers to how well the wind's kinetic energy is converted to electricity. The power coefficient (Cₚ) of the wind turbine is the ratio of the electricity generated by the wind turbine to the available wind power. The thrust coefficient (C_{T}) of the wind turbine is a non-dimensional number that describes the force exerted by the wind turbine in the axial direction to the incoming momentum of the flow. In the case of a wind turbine with a high-thrust coefficient, the wake becomes turbulent very close to the rotor and the recovery is enhanced. A 4D printed wind turbine, as used herein, refers to a wind turbine that is designed and fabricated using 4D printing, a process that combines 3D printing with smart materials and mathematics. In one embodiment, the optimal values for the power coefficient and the thrust coefficient for each of the wind turbines (e.g., 4D printed wind turbines) in the wind farm that minimize the aggregated wake loss for the wind farm are determined by analyzing a wind profile (e.g., speed, direction), weather parameters (air density, temperature, pressure), and the layout of the wind farm. Upon determining such optimal values for the power coefficient and the thrust coefficient, the amount of external stimuli (e.g., heat, pressure, electricity) to be applied to each of the wind turbines (e.g., 4D printed wind turbines) in the wind farm that would cause the values of the power coefficient and the thrust coefficient for each of the wind turbines in the wind farm to correspond to such optimal values is computed, such as based on the characteristics of the wind turbines (e.g., characteristics of the blades of the 4D printed wind turbines). The wind turbine controllers for each of the wind turbines are then instructed to apply such a determined amount of external stimuli for each of the wind turbines thereby changing the pitch angle and the tip speed ratio of the wind turbines, which dynamically adjusts the power coefficient and the thrust coefficient for each of the wind turbines to correspond to the optimal values that results in minimizing the aggregated wake loss for the wind farm. In this manner, the overall wake loss in the wind farm is effectively minimized thereby maximizing the collective wind power generation in the wind farm. A further discussion regarding these and other features is provided below.

In some embodiments of the present disclosure, the present disclosure comprises a computer-implemented method, system, and computer program product for minimizing wake loss in wind farms. In one embodiment of the present disclosure, the optimal values for the power coefficient and the thrust coefficient for each of the wind turbines (e.g., 4D printed wind turbines) in the wind farm that minimize the aggregated wake loss for the wind farm are determined. The power coefficient (Cₚ) of a wind turbine, as used herein, refers to how well the wind's kinetic energy is converted to electricity. The power coefficient (Cₚ) of the wind turbine is the ratio of the electricity generated by the wind turbine to the available wind power. The thrust coefficient (C_{T}) of the wind turbine is a non-dimensional number that describes the force exerted by the wind turbine in the axial direction to the incoming momentum of the flow. The wind turbine controllers for each of the wind turbines are then instructed to change the pitch angle and the tip speed ratio for the wind turbines in the wind farm using external stimuli to dynamically adjust the power coefficient and the thrust coefficient for each of the wind turbines to correspond to the optimal values that results in minimizing the aggregated wake loss for the wind farm. In this manner, the overall wake loss in the wind farm is effectively minimized thereby maximizing the collective wind power generation in the wind farm.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

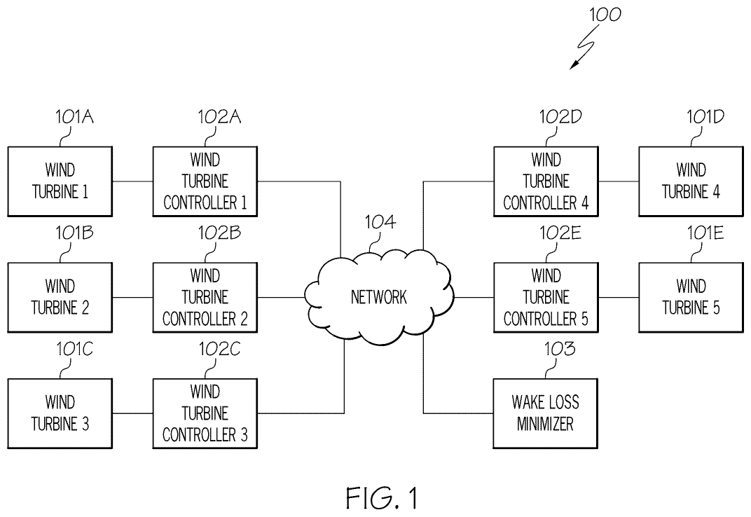

Referring now to the Figures in detail, FIG. 1 illustrates an embodiment of the present disclosure of a wind farm 100 that includes a collection of wind turbines 101A-101E (identified as “Wind Turbine 1,” “Wind Turbine 2,” “Wind Turbine 3,” “Wind Turbine 4,” and “Wind Turbine 5,” respectively, in FIG. 1) that work together to generate electricity from the wind. Wind turbines 101A-101E may collectively or individually be referred to as wind turbines 101 or wind turbine 101, respectively. While FIG. 1 illustrates five wind turbines 101, wind farm 100 may include any number of wind turbines 101.

Wind turbine 101, as used herein, refers to a machine that converts wind energy into electricity. In one embodiment, wind turbine 101 uses the force of the wind to spin a rotor (rotating part of the wind turbine), which is connected to a generator that creates electricity. The rotor blades are designed to crate lift, which is stronger than the drag, causing the rotor to spin. Examples of wind turbines 101 include, but are not limited to, Darrieus wind turbines, Giromills, Savonius wind turbines, airborne wind turbines, floating wind turbines, etc.

In one embodiment, wind turbines 101 are placed in rows on wind farm 100, such as 8-12 rotor diameters apart in the wind direction, and 3-5 rotor diameters apart in the crosswind direction.

In one embodiment, wind turbines 101 correspond to 4D printed wind turbines. A 4D printed wind turbine, as used herein, refers to wind turbines that are designed and fabricated using 4D printing, a process that combines 3D printing with smart materials and mathematics. 4D printing allows for the creation of smart structures that can change over time in a predictable way. For example, 4D printed wind turbine blades can have several advantages, including having reversible bend-twist coupling, not requiring electromechanical actuators or moving parts, can change shape without the need for conventional manufacturing processes, etc.

Furthermore, as illustrated in FIG. 1, wind farm 100 includes wind turbine controllers 102A-102E (identified as “Wind Turbine Controller 1,” “Wind Turbine Controller 2,” “Wind Turbine Controller 3,” “Wind Turbine Controller 4,” and “Wind Turbine Controller 5,” respectively, in FIG. 1). Wind turbine controllers 102A-102E may collectively or individually be referred to as wind turbine controllers 102 or wind turbine controller 102, respectively.

Wind turbine controller 102, as used herein, refers to the system for controlling an associated wind turbine 101, such as by turning the blades of wind turbine 101 into the prevailing wind, adjust the angle of the blades of wind turbine 101 to compensate for changing wind speeds, turning off wind turbine 101, restarting wind turbine 101, etc.

In one embodiment, each wind turbine 101 has its own dedicated wind turbine controller 102 that manages its operation as well as adjusts blade pitch, yaw angle, and generator speed based on wind conditions to optimize the power generation and ensure safe operation.

In one embodiment, wind turbine controller 102 is configured to change a pitch angle and a tip speed ratio for the associated wind turbine 101, such as the pitch angle and the tip speed ratio of the blades of wind turbine 101, to adjust the values of the power coefficient and the thrust coefficient of wind turbines 101.

The power coefficient (Cₚ) of a wind turbine, as used herein, refers to how well the wind's kinetic energy is converted to electricity. The power coefficient (Cₚ) of the wind turbine is the ratio of the electricity generated by the wind turbine to the available wind power. The power coefficient (Cₚ) is influenced by several factors, such as, but not limited to, blade airfoil, pitch angle, wind rotor diameter, and rotational speed of the wind rotor.

The thrust coefficient (C_{T}) of the wind turbine is a non-dimensional number that describes the force exerted by the wind turbine in the axial direction to the incoming momentum of the flow. In the case of a wind turbine with a high-thrust coefficient, the wake becomes turbulent very close to the rotor and the recovery is enhanced.

As discussed above, wind turbine controller 102 is configured to change a pitch angle and a tip speed ratio for the associated wind turbine 101 to adjust the values of the power coefficient and the thrust coefficient of wind turbines 101. In one embodiment, wind turbine controller 102 adjusts the pitch angle and the tip speed ratio of wind turbine 101 by adjusting the angle of the blades of wind turbine 101 using a pitch control system, which directly impacts the rotational speed of the rotor thereby altering the tip speed ratio. That is, by changing the blade pitch, the amount of wind energy that is captured, and consequently, the wind turbine's power output at different wind speeds can be controlled.

In one embodiment, the pitch angle is adjusted by rotating the blades around their axis thereby effectively changing the angle at which the wind strikes them. A higher pitch angle means that the blades are more angled against the wind thereby reducing power generation; whereas, a lower pitch angle allows for more efficient energy capture.

In one embodiment, by adjusting the pitch angle, the tip speed ratio (the ratio of the blade tip speed to the wind speed) can be manipulated so as to maintain an optimal tip speed ratio for maximum power output across varying wind conditions.

In one embodiment, wind turbine controller 102 is designed and implemented using the reference open-source controller (ROSCO) framework.

Other examples of wind turbine controller 102 include, but are not limited to, DTU² controller, TUB controller, etc.

As illustrated in FIG. 1, wind turbine controllers 102 are connected to a wake loss minimizer 103 via a network 104. Network 104 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with wind farm 100 of FIG. 1 without departing from the scope of the present disclosure.

In one embodiment, wake loss minimizer 103 is configured to minimize the overall wake loss in wind farm 100 thereby maximizing the collective wind power generation in wind farm 100.

In one embodiment, wake loss minimizer 103 analyzes a wind profile (e.g., speed, direction), weather parameters (air density, temperature, pressure), and the layout of wind farm 100. Based on such an analysis, wake loss minimizer 103 determines the optimal values for the power coefficient and the thrust coefficient for each of the wind turbines 101 (e.g., 4D printed wind turbines) in wind farm 100 that minimize the aggregated wake loss for wind farm 100.

In one embodiment, upon determining such optimal values for the power coefficient and the thrust coefficient, wake loss minimizer 103 computes the amount of external stimuli (e.g., heat, pressure, electricity) to be applied to each of the wind turbines 101 (e.g., 4D printed wind turbines) in wind farm 100 that dynamically adjusts the power coefficient and the thrust coefficient for each of the wind turbines 101 (e.g., 4D printed wind turbines) to correspond to the optimal values that results in minimizing the aggregated wake loss for wind farm 100. In one embodiment, such an amount of external stimuli is computed based on the characteristics of wind turbines 101 (e.g., characteristics of the blades of the 4D printed wind turbines).

In one embodiment, wake loss minimizer 103 instructs wind turbine controllers 102 for each of the associated wind turbines 101 to apply such a determined amount of external stimuli for each of its associated wind turbines 101 thereby resulting in changing the pitch angle and the tip speed ratio, which dynamically adjusts the power coefficient and the thrust coefficient for each of the wind turbines 101 (e.g., 4D printed wind turbines) to correspond to the optimal values that results in minimizing the aggregated wake loss for wind farm 100. In this manner, the overall wake loss in wind farm 100 is effectively minimized thereby maximizing the collective wind power generation in wind farm 100. A further discussion regarding these and other features is provided below.

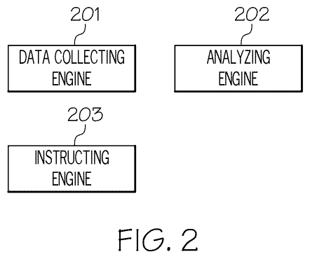

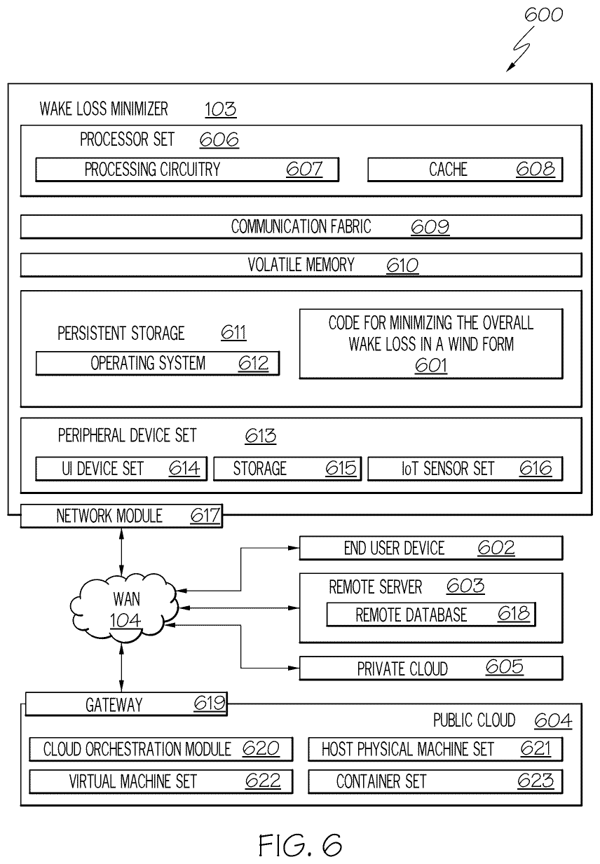

A description of the software components of wake loss minimizer 103 used for minimizing the overall wake loss in wind farm 100 thereby maximizing the collective wind power generation in wind farm 100 is provided below in connection with FIG. 2. A description of the hardware configuration of wake loss minimizer 103 is provided further below in connection with FIG. 6.

Wind farm 100 is not to be limited in scope to any one particular network architecture. Wind farm 100 may include any number of wind turbines 101, wind turbine controllers 102, wake loss minimizers 103, and networks 104.

Referring now to FIG. 2, FIG. 2 is a diagram of the software components of wake loss minimizer 103 used for minimizing the overall wake loss in wind farm 100 thereby maximizing the collective wind power generation in wind farm 100 in accordance with an embodiment of the present disclosure.

As shown in FIG. 2, in conjunction with FIG. 1, wake loss minimizer 103 includes data collecting engine 201 configured to obtain the wind profile (e.g., speed, direction), weather parameters (air density, temperature, pressure), the layout of wind farm 100, and the characteristics of wind turbines 101 (e.g., characteristics of the blades of the 4D printed wind turbines).

The wind profile, as used herein, refers to the variation in wind speed and direction with altitude, influenced by factors, such as synoptic pressure gradient, temperature profile, and surface roughness. In one embodiment, the wind profile is calculated using a variety of methods, such as, but not limited to, Monin-Obukhov similarity theory, a wind profiler (weather observing equipment that uses radar or sound waves to measure wind speed and direction at different elevations), etc. Wind profiles are influenced by a number of factors, including, but not limited to, the synoptic pressure gradient, the vertical temperature profile, the surface roughness, atmospheric stability, momentum exchanges, and weather conditions.

In one embodiment, data collecting engine 201 obtains the wind profile using atmospheric reanalysis data, such as the fifth-generation ECMWF reanalysis (ERA5) produced by the Copernicus Climate Change Service (C3S), which can be used to derive wind profiles. In another embodiment, data collecting engine 201 obtains the wind profile using spaceborne instruments, such as the atmospheric laser doppler instrument on the Aeolus mission that provides line-of-sight wind profile data. Furthermore, in one embodiment, data collecting engine 201 obtains the wind profile using ground base measurements, such as wind measurements from towers or radar wind or lidar wind profilers, which provide precise wind profiles for a specific location. Additionally, in one embodiment, data collecting engine 201 obtains the wind profile using surface and mixed layer scaling models, which generate wind profiles by considering factors, such as surface heat, mixing depth, and terrain effects. Furthermore, in one embodiment, data collecting engine 201 obtains the wind profile using doppler lidars, radar wind profilers, or sodar wind profilers.

In one embodiment data collecting engine 201 obtains such wind profiles to determine wind characteristics, such as speed, direction, etc. In one embodiment, data collecting 201 analyzes wind profiles to determine such wind characteristics using various software tools, such as, but are not limited to, Windnavigator, WINDExchange, WAsP, SimFlow CFD, etc.

Weather parameters, as used herein, refer to the factors that describe the weather and climate of a local area, including, but not limited to, air density (mass of a quantity of air divided by its volume), temperature, pressure (amount of force exerted on an object by the weight of the air above it), etc.

In one embodiment, data collecting engine 201 obtains such weather parameters from OpenWeatherMap (online service that provides weather data), National Weather Service (NWS) (U.S. federal agency that provides weather forecasts), Weatherbit (provides weather data for current, historical, and forecasted conditions in over 45 fields, such as temperature, pressure, due point, wind speed, wind direction, etc.), Meteomatics (uses a weather drone system to collect atmospheric data, such as temperature, humidity, wind, etc.), etc.

In one embodiment, data collecting engine 201 analyzes such weather parameters to determine the weather and climate of a local area using various software tools, such as National Oceanic and Atmospheric Administration's (NOAA's) Advanced Weather Information Processing System (AWIPS), etc.

In one embodiment, data collecting engine 201 obtains the layout of wind farm 100 by a user inputting the current layout of wind farm 100 to data collecting engine 201, such as via a user interface of wake loss minimizer 103. The layout of wind farm 100, as used herein, refers to the physical locations of wind turbines 101 on wind farm 100.

In one embodiment, data collecting engine 201 obtains the layout of wind farm 100 by accessing a data structure storing the current layout of wind farm 100. In one embodiment, such a data structure resides within the storage device of wake loss minimizer 103. In one embodiment, such a data structure is populated by an expert.

In one embodiment, the characteristics of wind turbines 101 include characteristics, such as size (e.g., wind turbines 101 can vary widely in size), blade length, blade design, blade rotation speed, etc. For example, such characteristics of wind turbines 101 include the thermodynamic shape of the blades of wind turbines 101 (e.g., 4D printed wind turbines), the shape memory alloy used to manufacture the blades of wind turbines 101 (e.g., 4D printed wind turbines), etc. In one embodiment, such characteristics of wind turbines 101 are directed to the characteristics of 4D printed wind turbines. A 4D printed wind turbine, as used herein, refers to wind turbines that are designed and fabricated using 4D printing, a process that combines 3D printing with smart materials and mathematics. 4D printing allows for the creation of smart structures that can change over time in a predictable way. For example, 4D printed wind turbine blades can have several advantages, including having reversible bend-twist coupling, not requiring electromechanical actuators or moving parts, can change shape without the need for conventional manufacturing processes, etc.

In one embodiment, data collecting engine 201 obtains the characteristics of wind turbines 101 by a user inputting the characteristics of wind turbines 101 to data collecting engine 201, such as via a user interface of wake loss minimizer 103.

In one embodiment, data collecting engine 201 obtains the characteristics of wind turbines 101 by accessing a data structure (e.g., table) storing the characteristics of wind turbines 101. In one embodiment, such a data structure resides within the storage device of wake loss minimizer 103. In one embodiment, such a data structure is populated by an expert.

In one embodiment, data collecting engine 201 utilizes various software tools for analyzing the characteristics of wind turbines 101, such as the blades of wind turbines 101 (e.g., 4D printed wind turbines), including, but are not limited to, Ansys® Fluent, QBlade, Bladed, etc.

Wake loss minimizer 103 further includes analyzing engine 202 configured to analyze the wind profile (e.g., speed, direction), weather parameters (air density, temperature, pressure), the layout of wind farm 100, and the characteristics of wind turbines 101 (e.g., characteristics of the blades of the 4D printed wind turbines) so to maximize the aggregated wind power generation of wind farm 100 by minimizing the overall wake loss in wind farm 100. In one embodiment, the overall wake loss in wind farm 100 is minimized by determining the optimal values for the power coefficient and the thrust coefficient for wind turbines 101 (e.g., 4D printed wind turbines) in wind farm 100 that minimize the wake loss for wind farm 100 based on such an analysis as discussed below.

In one embodiment, analyzing engine 202 determines the optimal values for the power coefficient and the thrust coefficient for wind turbines 101 (e.g., 4D printed wind turbines) in wind farm 100 that minimize the wake loss for wind farm 100 based on analyzing the wind profile, weather parameters and the layout of wind farm 100. The power coefficient determines the amount of mechanic power harvested by the upstream wind turbine 101; whereas, the thrust coefficient determines the wake loss for downstream wind turbines 101. It is noted that the optimal values for the power coefficient and the thrust coefficient may differ for each wind turbine 101 of wind farm 100 and that such computations are independently ascertained for each wind turbine 101.

The power coefficient (Cₚ) of wind turbine 101, as used herein, refers to how well the wind's kinetic energy is converted to electricity. The power coefficient (Cₚ) of wind turbine 101 is the ratio of the electricity generated by wind turbine 101 to the available wind power. The power coefficient (Cₚ) is influenced by several factors, such as, but not limited to, blade airfoil, pitch angle, wind rotor diameter, and rotational speed of the wind rotor.

The thrust coefficient (C_{T}) of wind turbine 101, as used herein, is a non-dimensional number that describes the force exerted by wind turbine 101 in the axial direction to the incoming momentum of the flow. In the case of wind turbine 101 with a high-thrust coefficient, the wake becomes turbulent very close to the rotor and the recovery is enhanced.

In one embodiment, analyzing engine 202 determines the power coefficient (Cₚ) of wind turbine 101 and the thrust coefficient (C_{T}) of wind turbine 101 that minimize the wake loss for wind farm 100 based on building and training a machine learning model to determine such optimal values for the power coefficient (Cₚ) of wind turbine 101 and the thrust coefficient (C_{T}) of wind turbine 101 that minimize the wake loss for wind farm 100 based on analyzing the wind profile, weather parameters and the layout of wind farm 100.

In one embodiment, analyzing engine 202 trains the machine learning model to determine the optimal values for the power coefficient (Cₚ) of wind turbine 101 and the thrust coefficient (C_{T}) of wind turbine 101 that minimize the wake loss for wind farm 100 based on a sample data set, which may include information, such as, but not limited to, the values of the power and thrust coefficients of wind turbines 101 based on the wind profiles, weather parameters and the layouts of wind farms, such as wind farm 100. In one embodiment, such a sample data set is acquired by data collecting engine 201 for various wind farms 100 in the manner discussed above. In one embodiment, such a sample data set is populated by an expert. In one embodiment, such a sample data set is stored in a storage device of wake loss minimizer 103.

Furthermore, in one embodiment, the sample data set discussed above is referred to herein as the “training data,” which is used by a machine learning algorithm to make predictions or decisions, such as determining the optimal values for the power coefficient (Cₚ) of wind turbine 101 and the thrust coefficient (C_{T}) of wind turbine 101 that minimize the wake loss for wind farm 100. The algorithm iteratively makes predictions on the training data until the predictions achieve the desired accuracy as determined by an expert. Examples of such learning algorithms include nearest neighbor, Naïve Bayes, decision trees, linear regression, support vector machines, and neural networks.

Furthermore, in one embodiment, analyzing engine 202 determines the optimal value for the external stimuli for each wind turbine 101 in wind farm 100 to cause the value of the power coefficient (Cₚ) and the value of the thrust coefficient (C_{T}) for each wind turbine 101 in wind farm 100 to correspond to the determined optimal values for the power coefficient and the thrust coefficient. It is noted that the optimal value for the external stimuli may differ for each wind turbine 101 of wind farm 100 and that such a computation is independently ascertained for each wind turbine 101.

In the embodiment in which wind turbines 101 correspond to 4D printed wind turbines, for 4D printed wind turbine blades, the power coefficient and the thrust coefficient can be dynamically controlled by changing the pitch angle and the tip ratio of wind turbine 101 via external stimuli, such as increasing the heat for modifying the aerodynamic shape of the 4D printed wind turbine blades, which may be made from shape memory alloy. Shape memory alloy, as used herein, refers to a metal alloy that can return to its original shape when heated after being deformed, essentially “remembering” its pre-deformed shape due to a phase transformation within its crystal structure triggered by temperature changes. Examples of such a shape memory alloy that is used to manufacture the 4D printed wind turbine blades includes, but are not limited to, nickel-titanium, copper-aluminum-nickel, copper-zinc-aluminum-nickel, etc.

As discussed above, analyzing engine 202 determines the optimal value for the external stimuli for each wind turbine 101 in wind farm 100 to cause the value of the power coefficient (Cₚ) and the value of the thrust coefficient (C_{T}) for each wind turbine 101 in wind farm 100 to correspond to the determined optimal values for the power coefficient and the thrust coefficient so as to minimize the overall wake loss in wind farm 100 thereby maximizing the collective wind power generation in wind farm 100. The power coefficient and the thrust coefficient can be dynamically controlled by changing the pitch angle and the tip ratio via external stimuli as discussed below.

The power in the wind is given by

$${P}_{wind} = \frac{1}{2} ρ {A}_{0} {v}^{3} = \frac{1}{2} ρπ {R}^{2} {v}^{3} ,$$

where ρ is the density of the air, v is the velocity of the wind, such as in n/s, A₀ is the cross-sectional area of the wind, such as in m², and R is the rotational speed of the rotor.

The mechanical power extracted by wind turbine 101, is reflected by

$${P}_{WT} = \frac{1}{2} {C}_{P} ( β , λ ) ρ π {R}^{2} {v}^{3} ,$$

where β is the blade pitch angle, such as in degrees, and λ is the tip speed ratio, which corresponds to the ratio between the tangential speed of the tip of a blade and the actual speed of the wind, v. *con

The tip speed ratio, λ, is defined as a function of the rotor radius, R, and the rotational speed of the rotor, ωᵣ, which equals:

$$λ = \frac{R \cdot {ω}_{r}}{v} .$$

In one embodiment, the tip speed ratio, λ, is a function of D₀, which is the diameter of the rotor, d, which is the distance, and k, which is the wake effect constant, and equals:

$$\frac{v ( d )}{{v}_{0}} = \frac{1}{2} + \frac{1}{2} \sqrt{1 - 2 {C}_{T} ( β , λ ) {( \frac{{D}_{0}}{D ( d )} )}^{2}} D ( d ) = {D}_{0} + 2 k d$$

In one embodiment, increasing the Cₚ (power coefficient) will increase the power extracted by wind turbine 101. In one embodiment, decreasing the C_{T} (thrust coefficient) will decrease the decay of wind speed in downstream wind turbines 101, which will increase the wake loss.

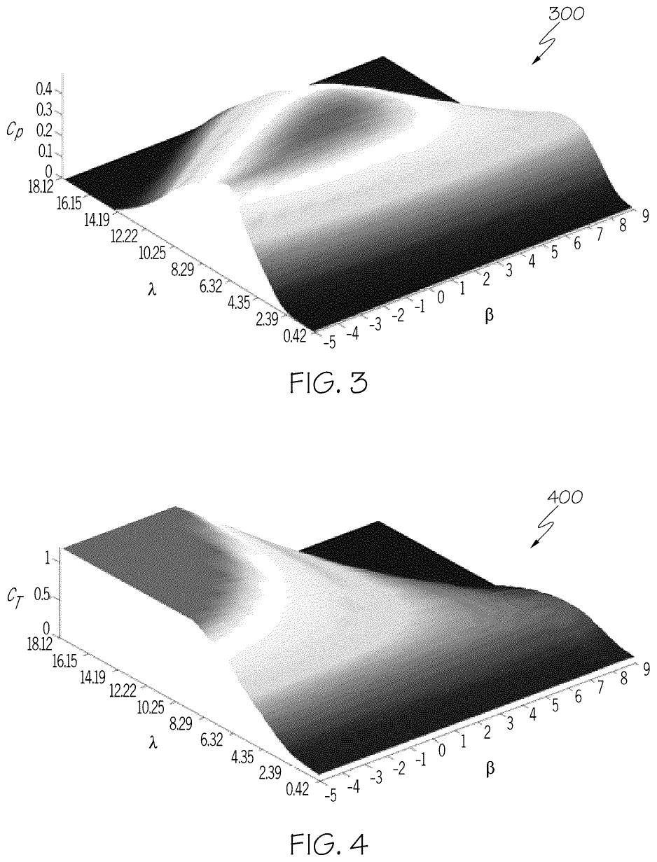

In one embodiment, the power coefficient, Cₚ, is a function of pitch angles (β) and the tip speed ratio, λ, as illustrated in FIG. 3.

FIG. 3 is a three-dimensional (3D) graph 300 illustrating that the power coefficient, Cₚ, is a function of pitch angles (β) and the tip speed ratio, λ, in accordance with an embodiment of the present disclosure.

As a result, by modifying the pitch angle and the tip speed ratio, the power coefficient, Cₚ, can be modified including being modified to the optimal value for minimizing the overall wake loss in wind farm 100.

In one embodiment, the thrust coefficient, C_{T}, is a function of pitch angles (β) and tip the speed ratio, λ, as illustrated in FIG. 4.

FIG. 4 is a three-dimensional (3D) graph 400 illustrating that the thrust coefficient, C_{T}, is a function of pitch angles (β) and the tip speed ratio, λ, in accordance with an embodiment of the present disclosure.

As a result, by modifying the pitch angle and the tip speed ratio, the thrust coefficient. C_{T}, can be modified including being modified to the optimal value for minimizing the overall wake loss in wind farm 100.

In one embodiment, the power coefficient and the thrust coefficient can be dynamically controlled by changing the pitch angle and the tip ratio via external stimuli, such as heat, pressure, and electricity.

In one embodiment, analyzing engine 202 determines the optimal value for the external stimuli for each wind turbine 101 in wind farm 100 to cause the value of the power coefficient and the value of the thrust coefficient for each of the wind turbines 101, such as 4D printed wind turbines, in wind farm 100 to correspond to the determined optimal values for the power coefficient and the thrust coefficient for that wind turbine 101 based on the characteristics of wind turbines 101.

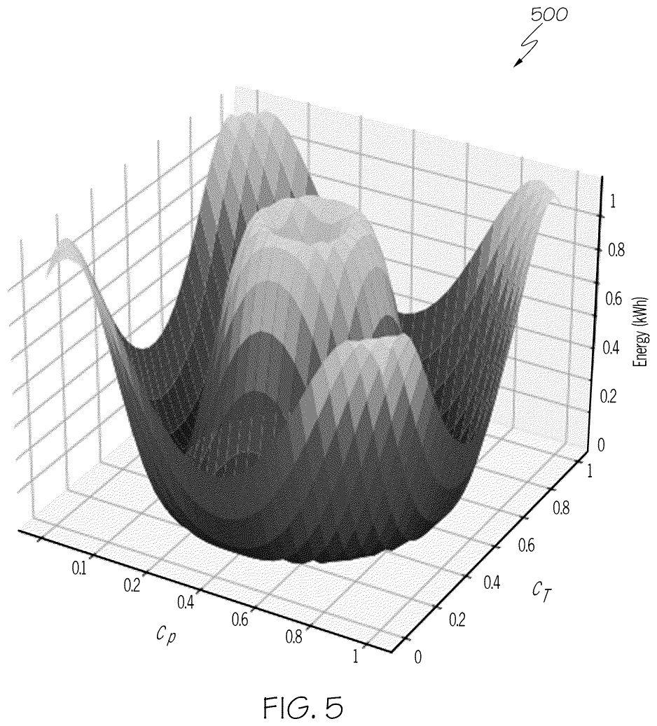

In one embodiment, analyzing engine 202 determines the optimal value for the external stimuli based on the characteristics of wind turbines 101 (e.g., type of shape memory alloy used to manufacture the wind blade) using a 3D lookup table. In one embodiment, a profile of the power coefficient (Cₚ), the thrust coefficient (C_{T}), and the required external stimuli (e.g., heat, pressure, electricity, etc.) to cause the value of the power coefficient and the value of the thrust coefficient for wind turbine 101, such as a 4D printed wind turbine, in wind farm 100 to correspond to the determined optimal values for the power coefficient and the thrust coefficient for that wind turbine 101 is published, such as by the manufacturers. For example, in embodiments in which the turbine blades of wind turbines 101, such as the 4D printed wind turbine blades, are manufactured from a shape memory alloy, the manufacturer of such turbine blades will publish such information based on the type of shape memory alloy (e.g., nickel-titanium, copper-aluminum-nickel, copper-zinc-aluminum-nickel) used to manufacture the turbine blade. In one embodiment, such information can be captured in a 3D lookup table as a knowledge base for each 4D printed wind blade as shown in FIG. 5.

FIG. 5 illustrates a three-dimensional (3D) lookup table 500 that identifies the required external stimuli, such as the amount of energy (kWh) used for heating the wind blade, to be applied to the wind turbine (e.g., wind turbine 101) to adjust the power coefficient and the thrust coefficient appropriately in accordance with an embodiment of the present disclosure.

As shown in FIG. 5, such a 3D lookup table 500 includes the required external stimuli, such as the amount of energy (kWh) used for heating the wind blade, for causing the value of the power coefficient (Cₚ) and the value of the thrust coefficient (C_{T}) for wind turbine 101, such as a 4D printed wind turbine, in wind farm 100 to correspond to the determined optimal values for the power coefficient and the thrust coefficient for that wind turbine 101 based on the type of shape memory alloy used for manufacturing the 4D printed wind blade of wind turbine 101.

In one embodiment, analyzing engine 202 determines the optimal value for the external stimuli by considering the tradeoff between the additional increase in the aggregated power generated by wind turbines 101 of wind farm 100 versus the energy lost in modifying the external stimuli (e.g., increasing heat) to an optimal value for each individual wind turbine 101. In one embodiment, such an analysis is captured in the framework discussed below.

In one embodiment, given the N_{WT}, the set of wind turbines 101 in wind farm 100, the objective is to find the optimal value of external stimuli for each individual wind turbine 101 to maximize the aggregated power generation by: (1) maximizing the power generated by the collective set of wind turbines 101 by optimally changing the thrust coefficient and the power coefficient of each wind turbine 101; and (2) minimizing the power required by the external stimuli (e.g., heating the 4D printed wind blades for shape deformation). A formula for such an analysis, which is performed by analyzing engine 202, is provided below:

$$J = Max {\sum }_{i = 1}^{NWT} \{ \frac{1}{2} {C}_{p} ( β i , λ i , S i ) ρ i π R 2 {v}_{i}^{′3} \} - \{ {w}_{s} S i ( {C}_{p} , {C}_{T} \}$$

where

$$\{ \frac{1}{2} {C}_{p} ( β i , λ i , S i ) ρ i π R 2 {v}_{i}^{′3} \}$$

corresponds to the energy generated by wind turbine 101 and {wₛ Si(Cₚ, C_{T}} corresponds to the energy lost in activating the external stimuli, where the formula J is subject to the constraints:

$$∀ i = 1 … NWT$$

$${λ}_{WT}^{min} \leq {λ}_{i} \leq {λ}_{WT}^{max}$$

$${β}_{WT}^{min} \leq β \leq {β}_{WT}^{max}$$

$${P}_{WT i} \leq {P}_{WT}^{max}$$

$$R \cdot {ω}_{ri} \leq {v}_{tip WT}^{max}$$

$${S}_{i} \leq {S}_{max}$$

where J is the cost function (energy gain);
Sᵢ is the optimal external stimuli for 4D printed wind turbine blades for power coefficient, Cₚ, and the thrust coefficient, C_{T};
λᵢ, is the tip speed ratio;
wₛ is the coefficient for external stimuli Sᵢ;
B is the pitch angle;
R is the radius of the 4D printed wind turbine rotor; and

$${v}_{i}^{′}$$

is the actual wind speed at 4D printed wind turbine ‘i’ considering the wake effect, given by

$$\frac{ν ( d )}{{v}_{0}} = \frac{1}{2} + \frac{1}{2} \sqrt{1 - 2 {C}_{T} ( β , λ ) {( \frac{{D}_{0}}{D ( d )} )}^{2}}$$

Returning to FIG. 2, wake loss minimizer 103 further includes instructing engine 203 configured to instruct wind turbine controllers 102 to change a pitch angle and a tip speed ratio for each wind turbine 101 in wind farm 100 using the determined optimal value for the external stimuli for each wind turbine 101 to cause the values of the power coefficient and the thrust coefficient for each wind turbine 101 to correspond to the determined optimal values.

In one embodiment, wind turbine controller 102 applies the external stimuli, such as heating the wind blades of wind turbine 101 at a certain rate over a certain duration of time based on the determined optimal value of the external stimuli. For example, wind turbine controller 102 applies a determined amount of heat to the wind blades of wind turbine 101 by controlling the flow of hot gas through the turbine, which is the result of combustion in a gas turbine engine of wind turbine 101. As a result of applying such heat to the wind blades, the shape of the wind blades, such as those manufactured from shape memory alloy, may be dynamically modified (e.g., changing of the curvature) thereby changing the pitch angle and tip speed ratio, which changes the power coefficient and thrust coefficient of wind turbine 101. For instance, the values of the power coefficient and the thrust coefficient of wind turbine 101 may be changed to the optimal values that minimize the overall wake loss in wind farm 100 thereby maximizing the collective wind power generation in wind farm 100.

In one embodiment, instructing engine 203 determines the amount of heat to be applied to the wind blades of wind turbine 101 by performing a look-up in a data structure (e.g., table) that lists the rate and duration of time to apply heat to the wind blades of wind turbine 101 based on the determined optimal value of the external stimuli. For example, such a data structure includes various rates and durations of time to apply heat to the wind blades of wind turbine 101 corresponding to various optimal values of the external stimuli. As a result, based on the determined optimal value for the external stimuli, instructing engine 203 determines the amount of heat to be applied to the wind blades of wind turbine 101 by performing a look-up in such a data structure that lists the rate and duration of time to apply heat to the wind blades of wind turbine 101 based on the determined optimal value of the external stimuli. In one embodiment, such a data structure resides within the storage device of wake loss minimizer 103. In one embodiment, such a data structure is populated by an expert.

Upon determining the amount of heat to be applied to the wind blades of wind turbine 101, instructing engine 203 instructs wind turbine controllers 102 to change a pitch angle and a tip speed ratio for each wind turbine 101 in wind farm 100 using the determined amount of heat to be applied to the wind blades for each wind turbine 101 to cause the values of the power coefficient and the thrust coefficient for each wind turbine 101 to correspond to the determined optimal values.

In another embodiment, the external stimuli corresponds to pressure. For example, wind turbine controller 102 applies the external stimuli, such as applying pressure to the wind blades of wind turbine 101 at a certain rate over a certain duration of time based on the determined optimal value of the external stimuli. For example, wind turbine controller 102 applies a determined amount of pressure to the wind blades of wind turbine 101 by controlling the force of hot gas through the turbine, which is the result of combustion in a gas turbine engine of wind turbine 101. Pressure is applied to the wind blades due to the force of the hot gas impacting the blade surface as it expands and pushes against the blade. As a result of applying such pressure to the wind blades, the shape of the wind blades, such as those manufactured from shape memory alloy, may be dynamically modified (e.g., changing of the curvature) thereby changing the pitch angle and tip speed ratio, which changes the power coefficient and thrust coefficient of wind turbine 101. For instance, the values of the power coefficient and the thrust coefficient of wind turbine 101 may be changed to the optimal values that minimize the overall wake loss in wind farm 100 thereby maximizing the collective wind power generation in wind farm 100.

In one embodiment, instructing engine 203 determines the amount of pressure to be applied to the wind blades of wind turbine 101 by performing a look-up in a data structure (e.g., table) that lists the rate and duration of time to apply pressure to the wind blades of wind turbine 101 based on the determined optimal value of the external stimuli. For example, such a data structure includes various rates and durations of time to apply pressure to the wind blades of wind turbine 101 corresponding to various optimal values of the external stimuli. As a result, based on the determined optimal value for the external stimuli, instructing engine 203 determines the amount of pressure to be applied to the wind blades of wind turbine 101 by performing a look-up in such a data structure that lists the rate and duration of time to apply pressure to the wind blades of wind turbine 101 based on the determined optimal value of the external stimuli. In one embodiment, such a data structure resides within the storage device of wake loss minimizer 103. In one embodiment, such a data structure is populated by an expert.

Upon determining the amount of pressure to be applied to the wind blades of wind turbine 101, instructing engine 203 instructs wind turbine controllers 102 to change a pitch angle and a tip speed ratio for each wind turbine 101 in wind farm 100 using the determined amount of pressure to be applied to the wind blades for each wind turbine 101 to cause the values of the power coefficient and the thrust coefficient for each wind turbine 101 to correspond to the determined optimal values.

In another embodiment, the external stimuli corresponds to electricity. For example, wind turbine controller 102 applies the external stimuli, such as applying electricity to the wind blades (e.g., actuators embedded within the wind blades) of wind turbine 101 at a certain rate over a certain duration of time based on the determined optimal value of the external stimuli. For example, wind turbine controller 102 applies a determined amount of electricity to the actuators embedded within the wind blades of wind turbine 101 to manipulate the blades internal structure, allowing it to adjust its airfoil profile, through the use of material (e.g., shape memory alloy) for the wind blades (e.g., 4D printed wind blades). For instance, such material (e.g., shape memory alloy) for the wind blades (e.g., 4D printed wind blades) may have bend-twist coupling properties that react to electrical input by changing their shape. As a result of applying such electricity to the actuators embedded within the wind blades to manipulate the blades internal structure, the shape of the wind blades, such as those manufactured from shape memory alloy, may be dynamically modified (e.g., changing of the curvature) thereby changing the pitch angle and tip speed ratio, which changes the power coefficient and thrust coefficient of wind turbine 101. For instance, the values of the power coefficient and the thrust coefficient of wind turbine 101 may be changed to the optimal values that minimize the overall wake loss in wind farm 100 thereby maximizing the collective wind power generation in wind farm 100.

In one embodiment, instructing engine 203 determines the amount of electricity to be applied to the wind blades (e.g., actuators embedded within the wind blades) of wind turbine 101 by performing a look-up in a data structure (e.g., table) that lists the rate and duration of time to apply the electricity to the wind blades (e.g., actuators embedded within the wind blades) of wind turbine 101 based on the determined optimal value of the external stimuli. For example, such a data structure includes various rates and durations of time to apply electricity to the wind blades (e.g., actuators embedded within the wind blades) of wind turbine 101 corresponding to various optimal values of the external stimuli. As a result, based on the determined optimal value for the external stimuli, instructing engine 203 determines the amount of electricity to be applied to the wind blades (e.g., actuators embedded within the wind blades) of wind turbine 101 by performing a look-up in such a data structure that lists the rate and duration of time to apply the electricity to the wind blades (e.g., actuators embedded within the wind blades) of wind turbine 101 based on the determined optimal value of the external stimuli. In one embodiment, such a data structure resides within the storage device of wake loss minimizer 103. In one embodiment, such a data structure is populated by an expert.

Upon determining the amount of electricity to be applied to the wind blades (e.g., actuators embedded within the wind blades) of wind turbine 101, instructing engine 203 instructs wind turbine controllers 102 to change a pitch angle and a tip speed ratio for each wind turbine 101 in wind farm 100 using the determined amount of electricity to be applied to the wind blades (e.g., actuators embedded within the wind blades) for each wind turbine 101 to cause the values of the power coefficient and the thrust coefficient for each wind turbine 101 to correspond to the determined optimal values.

In this manner, the overall wake loss in the wind farm (e.g., wind farm 100) is effectively minimized thereby maximizing the collective wind power generation in the wind farm.

A further description of these and other features is provided below in connection with the discussion of the method for minimizing the overall wake loss in a wind farm (e.g., wind farm 100) thereby maximizing the collective wind power generation in the wind farm.

Prior to the discussion of the method for minimizing the overall wake loss in a wind farm (e.g., wind farm 100) thereby maximizing the collective wind power generation in the wind farm, a description of the hardware configuration of wake loss minimizer 103 (FIG. 1) is provided below in connection with FIG. 6.

Referring now to FIG. 6, in conjunction with FIG. 1, FIG. 6 illustrates an embodiment of the present disclosure of the hardware configuration of wake loss minimizer 103 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code which is stored in block 601 involved in performing the disclosed methods, such as minimizing the overall wake loss in a wind farm (e.g., wind farm 100) thereby maximizing the collective wind power generation in the wind farm. In addition to block 601, computing environment 600 includes, for example, wake loss minimizer 103, network 104, such as a wide area network (WAN), end user device (EUD) 602, remote server 603, public cloud 604, and private cloud 605. In this embodiment, wake loss minimizer 103 includes processor set 606 (including processing circuitry 607 and cache 608), communication fabric 609, volatile memory 610, persistent storage 611 (including operating system 612 and block 601, as identified above), peripheral device set 613 (including user interface (UI) device set 614, storage 615, and Internet of Things (IoT) sensor set 616), and network module 617. Remote server 603 includes remote database 618. Public cloud 604 includes gateway 619, cloud orchestration module 620, host physical machine set 621, virtual machine set 622, and container set 623.

Wake loss minimizer 103 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 618. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically wake loss minimizer 103, to keep the presentation as simple as possible. Wake loss minimizer 103 may be located in a cloud, even though it is not shown in a cloud in FIG. 6. On the other hand, wake loss minimizer 103 is not required to be in a cloud except to any extent as may be affirmatively indicated.

Processor set 606 includes one, or more, computer processors of any type now known or to be developed in the future. Processing circuitry 607 may be distributed over multiple packages, for example, multiple, coordinated integrated circuit chips. Processing circuitry 607 may implement multiple processor threads and/or multiple processor cores. Cache 608 is memory that is located in the processor chip package(s) and is typically used for data or code that should be available for rapid access by the threads or cores running on processor set 606. Cache memories are typically organized into multiple levels depending upon relative proximity to the processing circuitry. Alternatively, some, or all, of the cache for the processor set may be located “off chip.” In some computing environments, processor set 606 may be designed for working with qubits and performing quantum computing.

Computer readable program instructions are typically loaded onto wake loss minimizer 103 to cause a series of operational steps to be performed by processor set 606 of wake loss minimizer 103 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 608 and the other storage media discussed below. The program instructions, and associated data, are accessed by processor set 606 to control and direct performance of the disclosed methods. In computing environment 600, at least some of the instructions for performing the disclosed methods may be stored in block 601 in persistent storage 611.

Communication fabric 609 is the signal conduction paths that allow the various components of wake loss minimizer 103 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 610 is any type of volatile memory now known or to be developed in the future. Examples include dynamic type random access memory (RAM) or static type RAM. Typically, the volatile memory is characterized by random access, but this is not required unless affirmatively indicated. In wake loss minimizer 103, the volatile memory 610 is located in a single package and is internal to wake loss minimizer 103, but, alternatively or additionally, the volatile memory may be distributed over multiple packages and/or located externally with respect to wake loss minimizer 103.

Persistent Storage 611 is any form of non-volatile storage for computers that is now known or to be developed in the future. The non-volatility of this storage means that the stored data is maintained regardless of whether power is being supplied to wake loss minimizer 103 and/or directly to persistent storage 611. Persistent storage 611 may be a read only memory (ROM), but typically at least a portion of the persistent storage allows writing of data, deletion of data and re-writing of data. Some familiar forms of persistent storage include magnetic disks and solid state storage devices. Operating system 612 may take several forms, such as various known proprietary operating systems or open source Portable Operating System Interface type operating systems that employ a kernel. The code included in block 601 typically includes at least some of the computer code involved in performing the disclosed methods.

Peripheral device set 613 includes the set of peripheral devices of wake loss minimizer 103. Data communication connections between the peripheral devices and the other components of wake loss minimizer 103 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 614 may include components such as a display screen, speaker, microphone, wearable devices (such as goggles and smart watches), keyboard, mouse, printer, touchpad, game controllers, and haptic devices. Storage 615 is external storage, such as an external hard drive, or insertable storage, such as an SD card. Storage 615 may be persistent and/or volatile. In some embodiments, storage 615 may take the form of a quantum computing storage device for storing data in the form of qubits. In embodiments where wake loss minimizer 103 is required to have a large amount of storage (for example, where wake loss minimizer 103 locally stores and manages a large database) then this storage may be provided by peripheral storage devices designed for storing very large amounts of data, such as a storage area network (SAN) that is shared by multiple, geographically distributed computers. IoT sensor set 616 is made up of sensors that can be used in Internet of Things applications. For example, one sensor may be a thermometer and another sensor may be a motion detector.

Network module 617 is the collection of computer software, hardware, and firmware that allows wake loss minimizer 103 to communicate with other computers through WAN 104. Network module 617 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 617 are performed on the same physical hardware device. In other embodiments (for example, embodiments that utilize software-defined networking (SDN)), the control functions and the forwarding functions of network module 617 are performed on physically separate devices, such that the control functions manage several different network hardware devices. Computer readable program instructions for performing the disclosed methods can typically be downloaded to wake loss minimizer 103 from an external computer or external storage device through a network adapter card or network interface included in network module 617.

WAN 104 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 602 is any computer system that is used and controlled by an end user (for example, a customer of an enterprise that operates wake loss minimizer 103), and may take any of the forms discussed above in connection with wake loss minimizer 103. EUD 602 typically receives helpful and useful data from the operations of wake loss minimizer 103. For example, in a hypothetical case where wake loss minimizer 103 is designed to provide a recommendation to an end user, this recommendation would typically be communicated from network module 617 of wake loss minimizer 103 through WAN 104 to EUD 602. In this way, EUD 602 can display, or otherwise present, the recommendation to an end user. In some embodiments, EUD 602 may be a client device, such as thin client, heavy client, mainframe computer, desktop computer and so on.

Remote server 603 is any computer system that serves at least some data and/or functionality to wake loss minimizer 103. Remote server 603 may be controlled and used by the same entity that operates wake loss minimizer 103. Remote server 603 represents the machine(s) that collect and store helpful and useful data for use by other computers, such as wake loss minimizer 103. For example, in a hypothetical case where wake loss minimizer 103 is designed and programmed to provide a recommendation based on historical data, then this historical data may be provided to wake loss minimizer 103 from remote database 618 of remote server 603.

Public cloud 604 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 604 is performed by the computer hardware and/or software of cloud orchestration module 620. The computing resources provided by public cloud 604 are typically implemented by virtual computing environments that run on various computers making up the computers of host physical machine set 621, which is the universe of physical computers in and/or available to public cloud 604. The virtual computing environments (VCEs) typically take the form of virtual machines from virtual machine set 622 and/or containers from container set 623. It is understood that these VCEs may be stored as images and may be transferred among and between the various physical machine hosts, either as images or after instantiation of the VCE. Cloud orchestration module 620 manages the transfer and storage of images, deploys new instantiations of VCEs and manages active instantiations of VCE deployments. Gateway 619 is the collection of computer software, hardware, and firmware that allows public cloud 604 to communicate through WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 605 is similar to public cloud 604, except that the computing resources are only available for use by a single enterprise. While private cloud 605 is depicted as being in communication with WAN 104 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 604 and private cloud 605 are both part of a larger hybrid cloud.

Block 601 further includes the software components discussed above in connection with FIGS. 2-5 to minimize the overall wake loss in a wind farm (e.g., wind farm 100) thereby maximizing the collective wind power generation in the wind farm. In one embodiment, such components may be implemented in hardware. The functions discussed above performed by such components are not generic computer functions. As a result, wake loss minimizer 103 is a particular machine that is the result of implementing specific, non-generic computer functions.

In one embodiment, the functionality of such software components of wake loss minimizer 103, including the functionality for minimizing the overall wake loss in a wind farm (e.g., wind farm 100) thereby maximizing the collective wind power generation in the wind farm, may be embodied in an application specific integrated circuit.

As stated above, wind power generated by wind farms is a renewable energy source that creates no solid waste, greenhouse gases, or other air pollutants. It also uses no water to generate electricity. Unfortunately, wind farms experience a loss of wind power energy due to “wake loss.” Wake loss is the reduction in wind speed and energy production caused by the wake effect of upstream wind turbines on downstream turbines. Wake losses can significantly impact the efficiency and performance of wind farms. For example, energy losses due to wake losses are approximately 5-10% for onshore wind farms and approximately 15% for offshore wind farms. Attempts have been made to mitigate the negative effects of wake loss. For example, attempts have been made to lessen the energy losses due to wake losses through turbine placement strategies and load distribution adjustments. In another example, data-driven model and machine learning techniques have been used to analyze and mitigate wake losses. Unfortunately, such attempts have been inadequate in minimizing wake losses, which reduces the energy production of the wind farm.

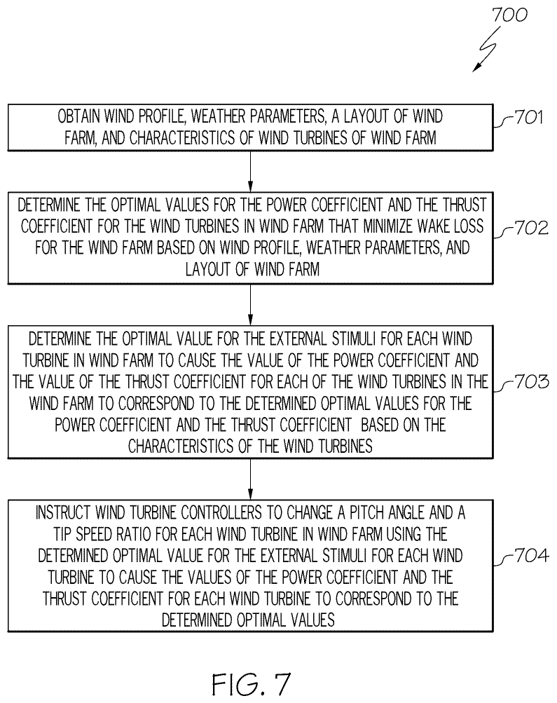

The embodiments of the present disclosure provide a means for minimizing the overall wake loss in the wind farm thereby maximizing the collective wind power generation in the wind farm as discussed below in connection with FIG. 7.

FIG. 7 is a flowchart of a method 700 for minimizing the overall wake loss in the wind farm thereby maximizing the collective wind power generation in the wind farm in accordance with an embodiment of the present disclosure.

Referring to FIG. 7, in conjunction with FIGS. 1-6, in step 701, data collecting engine 201 of wake loss minimizer 103 obtains the wind profile (e.g., speed, direction), weather parameters (air density, temperature, pressure), the layout of wind farm 100, and the characteristics of wind turbines 101 of wind farm 100 (e.g., characteristics of the blades of the 4D printed wind turbines).

As discussed above, the wind profile, as used herein, refers to the variation in wind speed and direction with altitude, influenced by factors, such as synoptic pressure gradient, temperature profile, and surface roughness. In one embodiment, the wind profile is calculated using a variety of methods, such as, but not limited to, Monin-Obukhov similarity theory, a wind profiler (weather observing equipment that uses radar or sound waves to measure wind speed and direction at different elevations), etc. Wind profiles are influenced by a number of factors, including, but not limited to, the synoptic pressure gradient, the vertical temperature profile, the surface roughness, atmospheric stability, momentum exchanges, and weather conditions.

In one embodiment, data collecting engine 201 obtains the wind profile using atmospheric reanalysis data, such as the fifth-generation ECMWF reanalysis (ERA5) produced by the Copernicus Climate Change Service (C3S), which can be used to derive wind profiles. In another embodiment, data collecting engine 201 obtains the wind profile using spaceborne instruments, such as the atmospheric laser doppler instrument on the Aeolus mission that provides line-of-sight wind profile data. Furthermore, in one embodiment, data collecting engine 201 obtains the wind profile using ground base measurements, such as wind measurements from towers or radar wind or lidar wind profilers, which provide precise wind profiles for a specific location. Additionally, in one embodiment, data collecting engine 201 obtains the wind profile using surface and mixed layer scaling models, which generate wind profiles by considering factors, such as surface heat, mixing depth, and terrain effects. Furthermore, in one embodiment, data collecting engine 201 obtains the wind profile using doppler lidars, radar wind profilers, or sodar wind profilers.

In one embodiment data collecting engine 201 obtains such wind profiles to determine wind characteristics, such as speed, direction, etc. In one embodiment, data collecting engine 201 analyzes wind profiles to determine such wind characteristics using various software tools, such as, but are not limited to, Windnavigator, WINDExchange, WAsP, SimFlow CFD, etc.

Weather parameters, as used herein, refer to the factors that describe the weather and climate of a local area, including, but not limited to, air density (mass of a quantity of air divided by its volume), temperature, pressure (amount of force exerted on an object by the weight of the air above it), etc.

In one embodiment, data collecting engine 201 obtains such weather parameters from OpenWeatherMap (online service that provides weather data), National Weather Service (NWS) (U.S. federal agency that provides weather forecasts), Weatherbit (provides weather data for current, historical, and forecasted conditions in over 45 fields, such as temperature, pressure, due point, wind speed, wind direction, etc.), Meteomatics (uses a weather drone system to collect atmospheric data, such as temperature, humidity, wind, etc.), etc.

In one embodiment, data collecting engine 201 analyzes such weather parameters to determine the weather and climate of a local area using various software tools, such as, National Oceanic and Atmospheric Administration's (NOAA's) Advanced Weather Information Processing System (AWIPS), etc.

In one embodiment, data collecting engine 201 obtains the layout of wind farm 100 by a user inputting the current layout of wind farm 100 to data collecting engine 201, such as via a user interface of wake loss minimizer 103. The layout of wind farm 100, as used herein, refers to the physical locations of wind turbines 101 on wind farm 100.

In one embodiment, data collecting engine 201 obtains the layout of wind farm 100 by accessing a data structure storing the current layout of wind farm 100. In one embodiment, such a data structure resides within the storage device (e.g., storage device 611, 615) of wake loss minimizer 103. In one embodiment, such a data structure is populated by an expert.

In one embodiment, the characteristics of wind turbines 101 include characteristics, such as size (e.g., wind turbines 101 can vary widely in size), blade length, blade design, blade rotation speed, etc. For example, such characteristics of wind turbines 101 include the thermodynamic shape of the blades of wind turbines 101 (e.g., 4D printed wind turbines), the shape memory alloy used to manufacture the blades of wind turbines 101 (e.g., 4D printed wind turbines), etc. In one embodiment, such characteristics of wind turbines 101 are directed to the characteristics of 4D printed wind turbines. A 4D printed wind turbine, as used herein, refers to wind turbines that are designed and fabricated using 4D printing, a process that combines 3D printing with smart materials and mathematics. 4D printing allows for the creation of smart structures that can change over time in a predictable way. For example, 4D printed wind turbine blades can have several advantages, including having reversible bend-twist coupling, not requiring electromechanical actuators or moving parts, can change shape without the need for conventional manufacturing processes, etc.

In one embodiment, data collecting engine 201 obtains the characteristics of wind turbines 101 by a user inputting the characteristics of wind turbines 101 to data collecting engine 201, such as via a user interface of wake loss minimizer 103.

In one embodiment, data collecting engine 201 obtains the characteristics of wind turbines 101 by accessing a data structure (e.g., table) storing the characteristics of wind turbines 101. In one embodiment, such a data structure resides within the storage device (e.g., storage device 611, 615) of wake loss minimizer 103. In one embodiment, such a data structure is populated by an expert.

In one embodiment, data collecting engine 201 utilizes various software tools for analyzing the characteristics of wind turbines 101, such as the blades of wind turbines 101 (e.g., 4D printed wind turbines), including, but are not limited to, Ansys® Fluent, QBlade, Bladed, etc.

In step 702, analyzing engine 202 of wake loss minimizer 103 determines the optimal values for the power coefficient and the thrust coefficient for wind turbines 101 (e.g., 4D printed wind turbines) in wind farm 100 that minimize the wake loss for wind farm 100 based on analyzing the wind profile, weather parameters and the layout of wind farm 100. It is noted that the optimal values for the power coefficient and the thrust coefficient may differ for each wind turbine 101 of wind farm 100 and that such computations are independently ascertained for each wind turbine 101.

As stated above, analyzing engine 202 analyzes the wind profile (e.g., speed, direction), weather parameters (air density, temperature, pressure), and the layout of wind farm 100 to determine the optimal values for the power coefficient and the thrust coefficient for wind turbines 101 (e.g., 4D printed wind turbines) in wind farm 100 that minimize the wake loss for wind farm 100. The power coefficient determines the amount of mechanic power harvested by the upstream wind turbine 101; whereas, the thrust coefficient determines the wake loss for downstream wind turbines 101.

The power coefficient (Cₚ) of wind turbine 101, as used herein, refers to how well the wind's kinetic energy is converted to electricity. The power coefficient (Cₚ) of wind turbine 101 is the ratio of the electricity generated by wind turbine 101 to the available wind power. The power coefficient (Cₚ) is influenced by several factors, such as, but not limited to, blade airfoil, pitch angle, wind rotor diameter, and rotational speed of the wind rotor.

The thrust coefficient (C_{T}) of wind turbine 101, as used herein, is a non-dimensional number that describes the force exerted by wind turbine 101 in the axial direction to the incoming momentum of the flow. In the case of wind turbine 101 with a high-thrust coefficient, the wake becomes turbulent very close to the rotor and the recovery is enhanced.

In one embodiment, analyzing engine 202 determines the power coefficient (Cₚ) of wind turbine 101 and the thrust coefficient (C_{T}) of wind turbine 101 that minimize the wake loss for wind farm 100 based on building and training a machine learning model to determine such optimal values for the power coefficient (Cₚ) of wind turbine 101 and the thrust coefficient (C_{T}) of wind turbine 101 that minimize the wake loss for wind farm 100 based on analyzing the wind profile, weather parameters and the layout of wind farm 100.

In one embodiment, analyzing engine 202 trains the machine learning model to determine the optimal values for the power coefficient (Cₚ) of wind turbine 101 and the thrust coefficient (C_{T}) of wind turbine 101 that minimize the wake loss for wind farm 100 based on a sample data set, which may include information, such as, but not limited to, the values of the power and thrust coefficients of wind turbines 101 based on the wind profiles, weather parameters and the layouts of wind farms, such as wind farm 100. In one embodiment, such a sample data set is acquired by data collecting engine 201 for various wind farms 100 in the manner discussed above. In one embodiment, such a sample data set is populated by an expert. In one embodiment, such a sample data set is stored in a storage device (e.g., storage device 611, 615) of wake loss minimizer 103.

Furthermore, in one embodiment, the sample data set discussed above is referred to herein as the “training data,” which is used by a machine learning algorithm to make predictions or decisions, such as determining the optimal values for the power coefficient (Cₚ) of wind turbine 101 and the thrust coefficient (C_{T}) of wind turbine 101 that minimize the wake loss for wind farm 100. The algorithm iteratively makes predictions on the training data until the predictions achieve the desired accuracy as determined by an expert. Examples of such learning algorithms include nearest neighbor, Naïve Bayes, decision trees, linear regression, support vector machines, and neural networks.

In step 703, analyzing engine 202 of wake loss minimizer 103 determines the optimal value for the external stimuli for each wind turbine 101 in wind farm 100 to cause the value of the power coefficient (Cₚ) and the value of the thrust coefficient (C_{T}) for each wind turbine 101 in wind farm 100 to correspond to the determined optimal values for the power coefficient and the thrust coefficient based on the characteristics of wind turbines 101, such as the characteristics of the blades of wind turbines 101. It is noted that the optimal value for the external stimuli may differ for each wind turbine 101 of wind farm 100 and that such a computation is independently ascertained for each wind turbine 101.

In the embodiment in which wind turbines 101 correspond to 4D printed wind turbines, for 4D printed wind turbine blades, the power coefficient and the thrust coefficient can be dynamically controlled by changing the pitch angle and the tip ratio of wind turbine 101 via external stimuli, such as increasing the heat for modifying the aerodynamic shape of the 4D printed wind turbine blades, which may be made from shape memory alloy, Shape memory alloy, as used herein, refers to a metal alloy that can return to its original shape when heated after being deformed, essentially “remembering” its pre-deformed shape due to a phase transformation within its crystal structure triggered by temperature changes. Examples of such a shape memory alloy that is used to manufacture the 4D printed wind turbine blades includes, but are not limited to, nickel-titanium, copper-aluminum-nickel, copper-zinc-aluminum-nickel, etc.

As discussed above, analyzing engine 202 determines the optimal value for the external stimuli for each wind turbine 101 in wind farm 100 to cause the value of the power coefficient (Cₚ) and the value of the thrust coefficient (C_{T}) for each wind turbine 101 in wind farm 100 to correspond to the determined optimal values for the power coefficient and the thrust coefficient so as to minimize the overall wake loss in wind farm 100 thereby maximizing the collective wind power generation in wind farm 100. The power coefficient and the thrust coefficient can be dynamically controlled by changing the pitch angle and the tip ratio via external stimuli as discussed below.

The power in the wind is given by

$${{P}_{wind} = \frac{1}{2} ρ {A}_{0} {v}^{3} = \frac{1}{2} ρ π {R}^{2} {v}^{3} ,}^{\text{?}}$$

$$\text{?} \text{indicates text missing or illegible when filed}$$

where ρ is the density of the air, v is the velocity of the wind, such as in m/s. A₀ is the cross-sectional area of the wind, such as in m², and R is the rotational speed of the rotor.

The mechanical power extracted by wind turbine 101, is reflected by

$${P}_{WT} = \frac{1}{2} {C}_{P} ( β , λ ) ρπ {R}^{2} {v}^{3} ,$$

where β is the blade pitch angle, such as in degrees, and λ is the tip speed ratio, which corresponds to the ratio between the tangential speed of the tip of a blade and the actual speed of the wind, v.

The tip speed ratio, λ, is defined as a function of the rotor radius, R, and the rotational speed of the rotor, ωᵣ, which equals:

$$λ = \frac{R \cdot {ω}_{\text{?}}}{v} .$$

$$\text{?} \text{indicates text missing or illegible when filed}$$

In one embodiment, the tip speed ratio, λ, is a function of D₀, which is the diameter of the rotor, d, which is the distance, and k, which is the wake effect constant, and equals:

$$\frac{v ( d )}{{v}_{0}} = \frac{1}{2} + \frac{1}{2} \sqrt{1 - 2 {C}_{T} ( β , λ ) {( \frac{{D}_{0}}{D ( d )} )}^{2}} D ( d ) = {D}_{0} + 2 k d$$

In one embodiment, increasing the Cₚ (power coefficient) will increase the power extracted by wind turbine 101. In one embodiment, decreasing the C_{T} (thrust coefficient) will decrease the decay of wind speed in downstream wind turbines 101, which will increase the wake loss.

In one embodiment, the power coefficient, Cₚ, is a function of pitch angles (β) and the tip speed ratio, λ, as illustrated in FIG. 3.

As a result, by modifying the pitch angle and the tip speed ratio, the power coefficient, Cₚ, can be modified including being modified to the optimal value for minimizing the overall wake loss in wind farm 100.

In one embodiment, the thrust coefficient, C_{T}, is a function of pitch angles (β) and the tip speed ratio, λ, as illustrated in FIG. 4.

As a result, by modifying the pitch angle and the tip speed ratio, the thrust coefficient, C_{T}, can be modified including being modified to the optimal value for minimizing the overall wake loss in wind farm 100.

In one embodiment, the power coefficient and the thrust coefficient can be dynamically controlled by changing the pitch angle and the tip ratio via external stimuli, such as heat, pressure, and electricity.

In one embodiment, analyzing engine 202 determines the optimal value for the external stimuli for each wind turbine 101 in wind farm 100 to cause the value of the power coefficient and the value of the thrust coefficient for each of the wind turbines 101, such as 4D printed wind turbines, in wind farm 100 to correspond to the determined optimal values for the power coefficient and the thrust coefficient for that wind turbine 101 based on the characteristics of wind turbines 101.

In one embodiment, analyzing engine 202 determines the optimal value for the external stimuli based on the characteristics of wind turbines 101 (e.g., type of shape memory alloy used to manufacture the wind blade) using a 3D lookup table. In one embodiment, a profile of the power coefficient (Cₚ), the thrust coefficient (C_{T}), and the required external stimuli (e.g., heat, pressure, electricity, etc.) to cause the value of the power coefficient and the value of the thrust coefficient for wind turbine 101, such as a 4D printed wind turbine, in wind farm 100 to correspond to the determined optimal values for the power coefficient and the thrust coefficient for that wind turbine 101 is published, such as by the manufacturers. For example, in embodiments in which the turbine blades of wind turbines 101, such as the 4D printed wind turbine blades, are manufactured from a shape memory alloy, the manufacturer of such turbine blades will publish such information based on the type of shape memory alloy (e.g., nickel-titanium, copper-aluminum-nickel, copper-zinc-aluminum-nickel) used to manufacture the turbine blade. In one embodiment, such information can be captured in a 3D lookup table as a knowledge base for each 4D printed wind blade as shown in FIG. 5.

As shown in FIG. 5, such a 3D lookup table 500 includes the required external stimuli, such as the amount of energy (kWh) used for heating the wind blade, for causing the value of the power coefficient (Cₚ) and the value of the thrust coefficient (C_{T}) for wind turbine 101, such as a 4D printed wind turbine, in wind farm 100 to correspond to the determined optimal values for the power coefficient and the thrust coefficient for that wind turbine 101 based on the type of shape memory alloy used for manufacturing the 4D printed wind blade of wind turbine 101.

In one embodiment, analyzing engine 202 determines the optimal value for the external stimuli by considering the tradeoff between the additional increase in the aggregated power generated by wind turbines 101 of wind farm 100 versus the energy lost in modifying the external stimuli (e.g., increasing heat) to an optimal value for each individual wind turbine 101. In one embodiment, such an analysis is captured in the framework discussed below.

In one embodiment, given the N_{WT}, the set of wind turbines 101 in wind farm 100, the objective is to find the optimal value of external stimuli for each individual wind turbine 101 to maximize the aggregated power generation by: (1) maximizing the power generated by the collective set of wind turbines 101 by optimally changing the thrust coefficient and the power coefficient of each wind turbine 101; and (2) minimizing the power required by the external stimuli (e.g., heating the 4D printed wind blades for shape deformation), A formula for such an analysis, which is performed by analyzing engine 202, is provided below:

$$J = Max {\sum }_{i = 1}^{NWT} \{ \frac{1}{2} {C}_{p} ( β i , λ i , S i ) ρ i π R 2 {v}_{i}^{′3} \} - \{ {w}_{s} S i ( {C}_{p} , {C}_{T} \}$$

where

$$\{ \frac{1}{2} {C}_{p} ( β i , λ i , S i ) ρ i π R 2 {v}_{i}^{′3} \}$$

corresponds to the energy generated by wind turbine 101 and {wₛ Si(Cₚ, C_{T}} corresponds to the energy lost in activating the external stimuli, where the formula J is subject to the constraints:

$$∀ i = 1 … NWT$$

$${λ}_{WT}^{min} \leq {λ}_{i} \leq {λ}_{WT}^{max}$$

$${β}_{WT}^{min} \leq β \leq {β}_{WT}^{max}$$

$${P}_{WT i} \leq {P}_{WT}^{max}$$

$$R \cdot {ω}_{ri} \leq {v}_{tip WT}^{max}$$

$${S}_{i} \leq {S}_{max}$$

where J is the cost function (energy gain);
Sᵢ is the optimal external stimuli for 4D printed wind turbine blades for power coefficient, Cₚ, and the thrust coefficient, C_{T};
λᵢ, is the tip speed ratio;
wₛ is the coefficient for external stimuli Sᵢ;
B is the pitch angle;
R is the radius of the 4D printed wind turbine rotor; and

$${v}_{i}^{′}$$

is the actual wind speed at 4D printed wind turbine ‘i’ considering the wake effect, given by

$$\frac{ν ( d )}{{v}_{0}} = \frac{1}{2} + \frac{1}{2} \sqrt{1 - 2 {C}_{T} ( β , λ ) {( \frac{{D}_{0}}{D ( d )} )}^{2}}$$

In step 704, instructing engine 203 of wake loss minimizer 103 instructs wind turbine controllers 102 to change a pitch angle and a tip speed ratio for each wind turbine 101 in wind farm 100 using the determined optimal value for the external stimuli for each wind turbine 101 to cause the values of the power coefficient and the thrust coefficient for each wind turbine 101 to correspond to the determined optimal values.

As stated above, in one embodiment, wind turbine controller 102 applies the external stimuli, such as heating the wind blades of wind turbine 101 at a certain rate over a certain duration of time based on the determined optimal value of the external stimuli. For example, wind turbine controller 102 applies a determined amount of heat to the wind blades of wind turbine 101 by controlling the flow of hot gas through the turbine, which is the result of combustion in a gas turbine engine of wind turbine 101. As a result of applying such heat to the wind blades, the shape of the wind blades, such as those manufactured from shape memory alloy, may be dynamically modified (e.g., changing of the curvature) thereby changing the pitch angle and tip speed ratio, which changes the power coefficient and thrust coefficient of wind turbine 101. For instance, the values of the power coefficient and the thrust coefficient of wind turbine 101 may be changed to the optimal values that minimize the overall wake loss in wind farm 100 thereby maximizing the collective wind power generation in wind farm 100.

In one embodiment, instructing engine 203 determines the amount of heat to be applied to the wind blades of wind turbine 101 by performing a look-up in a data structure (e.g., table) that lists the rate and duration of time to apply heat to the wind blades of wind turbine 101 based on the determined optimal value of the external stimuli. For example, such a data structure includes various rates and durations of time to apply heat to the wind blades of wind turbine 101 corresponding to various optimal values of the external stimuli. As a result, based on the determined optimal value for the external stimuli, instructing engine 203 determines the amount of heat to be applied to the wind blades of wind turbine 101 by performing a look-up in such a data structure that lists the rate and duration of time to apply heat to the wind blades of wind turbine 101 based on the determined optimal value of the external stimuli. In one embodiment, such a data structure resides within the storage device (e.g., storage device 611, 615) of wake loss minimizer 103. In one embodiment, such a data structure is populated by an expert.

Upon determining the amount of heat to be applied to the wind blades of wind turbine 101, instructing engine 203 instructs wind turbine controllers 102 to change a pitch angle and a tip speed ratio for each wind turbine 101 in wind farm 100 using the determined amount of heat to be applied to the wind blades for each wind turbine 101 to cause the values of the power coefficient and the thrust coefficient for each wind turbine 101 to correspond to the determined optimal values.

In another embodiment, the external stimuli corresponds to pressure. For example, wind turbine controller 102 applies the external stimuli, such as applying pressure to the wind blades of wind turbine 101 at a certain rate over a certain duration of time based on the determined optimal value of the external stimuli. For example, wind turbine controller 102 applies a determined amount of pressure to the wind blades of wind turbine 101 by controlling the force of hot gas through the turbine, which is the result of combustion in a gas turbine engine of wind turbine 101. Pressure is applied to the wind blades due to the force of the hot gas impacting the blade surface as it expands and pushes against the blade. As a result of applying such pressure to the wind blades, the shape of the wind blades, such as those manufactured from shape memory alloy, may be dynamically modified (e.g., changing of the curvature) thereby changing the pitch angle and tip speed ratio, which changes the power coefficient and thrust coefficient of wind turbine 101. For instance, the values of the power coefficient and the thrust coefficient of wind turbine 101 may be changed to the optimal values that minimize the overall wake loss in wind farm 100 thereby maximizing the collective wind power generation in wind farm 100.

In one embodiment, instructing engine 203 determines the amount of pressure to be applied to the wind blades of wind turbine 101 by performing a look-up in a data structure (e.g., table) that lists the rate and duration of time to apply pressure to the wind blades of wind turbine 101 based on the determined optimal value of the external stimuli. For example, such a data structure includes various rates and durations of time to apply pressure to the wind blades of wind turbine 101 corresponding to various optimal values of the external stimuli. As a result, based on the determined optimal value for the external stimuli, instructing engine 203 determines the amount of pressure to be applied to the wind blades of wind turbine 101 by performing a look-up in such a data structure that lists the rate and duration of time to apply pressure to the wind blades of wind turbine 101 based on the determined optimal value of the external stimuli. In one embodiment, such a data structure resides within the storage device (e.g., storage device 611, 615) of wake loss minimizer 103. In one embodiment, such a data structure is populated by an expert.

Upon determining the amount of pressure to be applied to the wind blades of wind turbine 101, instructing engine 203 instructs wind turbine controllers 102 to change a pitch angle and a tip speed ratio for each wind turbine 101 in wind farm 100 using the determined amount of pressure to be applied to the wind blades for each wind turbine 101 to cause the values of the power coefficient and the thrust coefficient for each wind turbine 101 to correspond to the determined optimal values.

In another embodiment, the external stimuli corresponds to electricity. For example, wind turbine controller 102 applies the external stimuli, such as applying electricity to the wind blades (e.g., actuators embedded within the wind blades) of wind turbine 101 at a certain rate over a certain duration of time based on the determined optimal value of the external stimuli. For example, wind turbine controller 102 applies a determined amount of electricity to the actuators embedded within the wind blades of wind turbine 101 to manipulate the blades internal structure, allowing it to adjust its airfoil profile, through the use of material (e.g., shape memory alloy) for the wind blades (e.g., 4D printed wind blades). For instance, such material (e.g., shape memory alloy) for the wind blades (e.g., 4D printed wind blades) may have bend-twist coupling properties that react to electrical input by changing their shape. As a result of applying such electricity to the actuators embedded within the wind blades to manipulate the blades internal structure, the shape of the wind blades, such as those manufactured from shape memory alloy, may be dynamically modified (e.g., changing of the curvature) thereby changing the pitch angle and tip speed ratio, which changes the power coefficient and thrust coefficient of wind turbine 101. For instance, the values of the power coefficient and the thrust coefficient of wind turbine 101 may be changed to the optimal values that minimize the overall wake loss in wind farm 100 thereby maximizing the collective wind power generation in wind farm 100.

In one embodiment, instructing engine 203 determines the amount of electricity to be applied to the wind blades (e.g., actuators embedded within the wind blades) of wind turbine 101 by performing a look-up in a data structure (e.g., table) that lists the rate and duration of time to apply the electricity to the wind blades (e.g., actuators embedded within the wind blades) of wind turbine 101 based on the determined optimal value of the external stimuli. For example, such a data structure includes various rates and durations of time to apply electricity to the wind blades (e.g., actuators embedded within the wind blades) of wind turbine 101 corresponding to various optimal values of the external stimuli. As a result, based on the determined optimal value for the external stimuli, instructing engine 203 determines the amount of electricity to be applied to the wind blades (e.g., actuators embedded within the wind blades) of wind turbine 101 by performing a look-up in such a data structure that lists the rate and duration of time to apply the electricity to the wind blades (e.g., actuators embedded within the wind blades) of wind turbine 101 based on the determined optimal value of the external stimuli. In one embodiment, such a data structure resides within the storage device (e.g., storage device 611, 615) of wake loss minimizer 103. In one embodiment, such a data structure is populated by an expert.

Upon determining the amount of electricity to be applied to the wind blades (e.g., actuators embedded within the wind blades) of wind turbine 101, instructing engine 203 instructs wind turbine controllers 102 to change a pitch angle and a tip speed ratio for each wind turbine 101 in wind farm 100 using the determined amount of electricity to be applied to the wind blades (e.g., actuators embedded within the wind blades) for each wind turbine 101 to cause the values of the power coefficient and the thrust coefficient for each wind turbine 101 to correspond to the determined optimal values.

In this manner, the overall wake loss in the wind farm (e.g., wind farm 100) is effectively minimized thereby maximizing the collective wind power generation in the wind farm.

Furthermore, the principles of the present disclosure improve the technology or technical field involving wind farms.

As discussed above, wind power generated by wind farms is a renewable energy source that creates no solid waste, greenhouse gases, or other air pollutants. It also uses no water to generate electricity. Unfortunately, wind farms experience a loss of wind power energy due to “wake loss.” Wake loss is the reduction in wind speed and energy production caused by the wake effect of upstream wind turbines on downstream turbines. Wake losses can significantly impact the efficiency and performance of wind farms. For example, energy losses due to wake losses are approximately 5-10% for onshore wind farms and approximately 15% for offshore wind farms. Attempts have been made to mitigate the negative effects of wake loss. For example, attempts have been made to lessen the energy losses due to wake losses through turbine placement strategies and load distribution adjustments. In another example, data-driven model and machine learning techniques have been used to analyze and mitigate wake losses. Unfortunately, such attempts have been inadequate in minimizing wake losses, which reduces the energy production of the wind farm.

Embodiments of the present disclosure improve such technology by determining the optimal values for the power coefficient and the thrust coefficient for each of the wind turbines (e.g., 4D printed wind turbines) in the wind farm that minimize the aggregated wake loss for the wind farm. The power coefficient (Cₚ) of a wind turbine, as used herein, refers to how well the wind's kinetic energy is converted to electricity. The power coefficient (Cₚ) of the wind turbine is the ratio of the electricity generated by the wind turbine to the available wind power. The thrust coefficient (C_{T}) of the wind turbine is a non-dimensional number that describes the force exerted by the wind turbine in the axial direction to the incoming momentum of the flow. The wind turbine controllers for each of the wind turbines are then instructed to change the pitch angle and the tip speed ratio for the wind turbines in the wind farm using external stimuli to dynamically adjust the power coefficient and the thrust coefficient for each of the wind turbines to correspond to the optimal values that results in minimizing the aggregated wake loss for the wind farm. In this manner, the overall wake loss in the wind farm is effectively minimized thereby maximizing the collective wind power generation in the wind farm. Furthermore, in this manner, there is an improvement in the technical field involving wind farms.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for minimizing wake loss in wind farms, the method comprising:
determining a first value for a power coefficient and a second value for a thrust coefficient for a wind turbine in a wind farm that minimize aggregated wake loss for said wind farm; and
instructing a wind turbine controller to change a pitch angle and a tip speed ratio for said wind turbine in said wind farm using external stimuli to cause a value of said power coefficient and a value of said thrust coefficient for said wind turbine in said wind farm to correspond to said first value and said second value, respectively.

2. The method as recited in claim 1 further comprising:
determining a value for said external stimuli for said wind turbine in said wind farm to cause said value of power coefficient and said value of said thrust coefficient for said wind turbine in said farm to correspond to said first value and said second value, respectively.

3. The method as recited in claim 2, wherein said value for said external stimuli is determined considering a tradeoff between an additional increase in aggregated power generated for said wind turbine versus energy lost in modifying said external stimuli to said value for said wind turbine.

4. The method as recited in claim 1, wherein said external stimuli comprises heat, pressure or electricity.

5. The method as recited in claim 4, wherein said heat modifies a thermodynamic shape of one or more blades of said wind turbine which changes said pitch angle and said tip speed ratio.

6. The method as recited in claim 1 further comprising:
analyzing a wind profile, weather parameters, and a layout of said wind farm; and
determining said first value for said power coefficient and said second value for said thrust coefficient for said wind turbine in said wind farm that minimize aggregated wake loss for said wind farm based on said analysis.

7. The method as recited in claim 1, wherein an amount of said external stimuli required to cause said value of said power coefficient and said value of said thrust coefficient for said wind turbine in said wind farm to correspond to said first value and said second value, respectively, is determined from a 3D lookup table containing a profile of said power coefficient, said thrust coefficient, and an amount of energy used for heating said blades based on a type of shape memory alloy used to manufacture 4D printed blades of said wind turbine in said wind farm to modify a thermodynamic shape of said 4D printed blades.

8. A computer program product for minimizing wake loss in wind farms, the computer program product comprising one or more computer readable storage mediums having program code embodied therewith, the program code comprising programming instructions for:
determining a first value for a power coefficient and a second value for a thrust coefficient for a wind turbine in a wind farm that minimize aggregated wake loss for said wind farm; and
instructing a wind turbine controller to change a pitch angle and a tip speed ratio for said wind turbine in said wind farm using external stimuli to cause a value of said power coefficient and a value of said thrust coefficient for said wind turbine in said wind farm to correspond to said first value and said second value, respectively.

9. The computer program product as recited in claim 8, wherein the program code further comprises the programming instructions for:
determining a value for said external stimuli for said wind turbine in said wind farm to cause said value of power coefficient and said value of said thrust coefficient for said wind turbine in said farm to correspond to said first value and said second value, respectively.

10. The computer program product as recited in claim 9, wherein said value for said external stimuli is determined considering a tradeoff between an additional increase in aggregated power generated for said wind turbine versus energy lost in modifying said external stimuli to said value for said wind turbine.

11. The computer program product as recited in claim 8, wherein said external stimuli comprises heat, pressure or electricity.

12. The computer program product as recited in claim 11, wherein said heat modifies a thermodynamic shape of one or more blades of said wind turbine which changes said pitch angle and said tip speed ratio.

13. The computer program product as recited in claim 8, wherein the program code further comprises the programming instructions for:
analyzing a wind profile, weather parameters, and a layout of said wind farm; and
determining said first value for said power coefficient and said second value for said thrust coefficient for said wind turbine in said wind farm that minimize aggregated wake loss for said wind farm based on said analysis.

14. The computer program product as recited in claim 8, wherein an amount of said external stimuli required to cause said value of said power coefficient and said value of said thrust coefficient for said wind turbine in said wind farm to correspond to said first value and said second value, respectively, is determined from a 3D lookup table containing a profile of said power coefficient, said thrust coefficient, and an amount of energy used for heating said blades based on a type of shape memory alloy used to manufacture 4D printed blades of said wind turbine in said wind farm to modify a thermodynamic shape of said 4D printed blades.

15. A system, comprising:
a memory for storing a computer program for minimizing wake loss in wind farms; and
a processor connected to the memory, wherein the processor is configured to execute program instructions of the computer program comprising:
determining a first value for a power coefficient and a second value for a thrust coefficient for a wind turbine in a wind farm that minimize aggregated wake loss for said wind farm; and
instructing a wind turbine controller to change a pitch angle and a tip speed ratio for said wind turbine in said wind farm using external stimuli to cause a value of said power coefficient and a value of said thrust coefficient for said wind turbine in said wind farm to correspond to said first value and said second value, respectively.

16. The system as recited in claim 15, wherein the program instructions of the computer program further comprise:
determining a value for said external stimuli for said wind turbine in said wind farm to cause said value of power coefficient and said value of said thrust coefficient for said wind turbine in said farm to correspond to said first value and said second value, respectively.

17. The system as recited in claim 16, wherein said value for said external stimuli is determined considering a tradeoff between an additional increase in aggregated power generated for said wind turbine versus energy lost in modifying said external stimuli to said value for said wind turbine.

18. The system as recited in claim 15, wherein said external stimuli comprises heat, pressure or electricity.

19. The system as recited in claim 18, wherein said heat modifies a thermodynamic shape of one or more blades of said wind turbine which changes said pitch angle and said tip speed ratio.

20. The system as recited in claim 15, wherein the program instructions of the computer program further comprise:
analyzing a wind profile, weather parameters, and a layout of said wind farm; and
determining said first value for said power coefficient and said second value for said thrust coefficient for said wind turbine in said wind farm that minimize aggregated wake loss for said wind farm based on said analysis.
